(19) United States
(12) Patent Application Publication
(10) Pub. No.: US 2007/0076266 A1
(43) Pub. Date: Apr. 5, 2007

(54) Scanning unit

(75) Inventor: Kaname Nagatani, Seongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/505,433

(22) Filed: Aug. 17, 2006

(30) Foreign Application Priority Data
Sep. 30, 2005 (KR) 2005-92137

(51) Int. Cl. H04N 1/04

(52) U.S. Cl. 358/474; 358/505

(57) ABSTRACT

A scanning unit includes first and second carriages, a first wire to make a closed loop supported by a plurality of first pulleys and connected to the first carriage to move the first carriage, a second wire to make an open loop supported by a plurality of second pulleys installed in the second carriage and connected to the first carriage, and a motor to drive the first wire.

### CROSS-REFERENCE TO RELATED APPLICATIONS

This application claims priority under 35 U.S.C. §119(a) from Korean Patent Application No. 10-2005-0092137, filed on Sep. 30, 2005, in the Korean Intellectual Property Office, the disclosure of which is incorporated herein in its entirety by reference.

### BACKGROUND OF THE INVENTION

1. Field of the Invention

The present general inventive concept relates to a scanning unit useable in a copier, a scanner, or a multifunctional device having a scanning function, and more particularly, to a scanning unit having two carriages moving in the same direction and to guide light reflected from a document to an imaging body.

2. Description of the Related Art

FIG. 1 is a view illustrating a conventional scanning unit having two carriages. Referring to FIG. 1, a reflection mirror 6 is mounted in a first carriage 1, and reflection mirrors 7 and 8 are mounted in a second carriage 2. The light L reflected from a document D on a transparent plate 5 is guided by reflection mirrors 6, 7, and 8 and is incident on an imaging body 3. The first and second carriages 1 and 2 move in direction A to scan the document D. FIG. 2 is a view illustrating a conventional device using a belt 9 for moving for the first and second carriages 1 and 2 of the conventional scanning unit of FIG. 1. Referring to FIG. 2, the belt 9 is supported by pulleys 11, 12, and 13. The pulley 13 is provided in the second carriage 2. The pulley 11 is a driving pulley and the pulley 12 is a driven pulley. The pulley 13 is a moving pulley, the pulleys 11 and 12 are fixed, and the first carriage 1 is connected to the belt 9. When a motor (not illustrated) rotates the pulley 11, the first carriage 1 moves at a first speed and the second carriage 2 moves at a second speed that is half of the moving speed of the first carriage 1 in the same direction as the first carriage 1 (i.e., direction A of FIG. 1). Thus, the scanning unit is difficult to assemble due to the complexity of the belt route.

### SUMMARY OF THE INVENTION

The present general inventive concept provides a scanning unit having a simplified wire route.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a scanning unit, including a fixed imaging body, a first carriage including a light source to radiate light onto a document to be scanned, a second carriage moveable with the first carriage to guide the light reflected from the document onto the imaging body, a first wire to make a closed loop supported by a plurality of first pulleys and connected to the first carriage to move the first carriage, a second wire to make an open loop supported by a plurality of second pulleys installed in the second carriage and connected to the first carriage, and a motor to drive the first wire.

The motor may rotate one of the first pulleys.

At least one of the first and second wires may be a synchro-mesh wire.

At least one of the first and second wires may be a timing belt.

The foregoing and/or other aspects and utilities of the present general inventive concept may also be achieved by providing a scanning unit, including first and second carriages having one or more reflection mirrors to move in a sub-scanning direction and to guide light reflected from a document onto an imaging body, a first wire to circulate in the sub-scanning direction and connected to the first carriage, a second wire to form an open loop in the sub-scanning direction, supported by two pulleys in the second carriage, and connected to the first carriage between the two pulleys, and a motor to drive the first wire.

The first wire may be one of a synchro-mesh wire and a timing belt.

The foregoing and/or other aspects and utilities of the present general inventive concept may also be achieved by providing a scanning unit, including a first carriage including a first mirror to receive reflected light and to further reflect the light, a first moving unit connected to the first carriage to move the first carriage at a first speed, the first moving unit including a closed loop wire and a plurality of first pulleys to rotate the closed loop wire, a second carriage including a plurality of second pulleys fixed thereto, and second and third mirrors to receive the light reflected from the first mirror and to further reflect the light towards an imaging body, and a second moving unit connected to the second carriage to move the second carriage at a second speed different from the first speed, the second moving unit including an open wire connected to the first carriage to move around the plurality of second pulleys due to a movement of the first carriage.

The first carriage may further include a light source to emit light towards the document-to-be-scanned to be reflected therefrom. The scanning unit may further include a driving unit to apply a driving force to at least one of the plurality of first pulleys to drive the rotation of the closed loop wire. The closed loop wire may be wrapped a plurality of times around at least one of the plurality of first pulleys.

The closed loop wire may include a straight wire and a spiral wire wound around the straight wire along a length of the straight wire. At least one of the plurality of first pulleys may include a plurality of projections to engage with a plurality of curves of the spiral wire wound around the straight wire. The closed loop wire may include a timing belt having a plurality of protrusions thereon. At least one of the plurality of first pulleys may include a toothed timing pulley having a plurality of ridges thereon to engage with the plurality of protrusions of the timing belt.

The foregoing and/or other aspects and utilities of the present general inventive concept may also be achieved by providing an image scanning apparatus, including a main body, imaging body, and a scanning unit, the scanning unit including a first carriage including a first mirror to receive light reflected from a document-to-be-scanned and to further reflect the light, a first moving unit connected to the first carriage to move the first carriage at a first speed, the first moving unit including a closed loop wire and a plurality of first pulleys to rotate the closed loop wire, a second carriage including a plurality of second pulleys fixed thereto, and second and third mirrors to receive the light reflected from the first mirror and to further reflect the light towards the imaging body, and a second moving unit connected to the second carriage to move the second carriage at a second speed different from the first speed, the second moving unit including an open wire connected to the first carriage to move around the plurality of second pulleys due to a movement of the first carriage.

The imaging body may be fixed to the main body. The apparatus may further include a condensing lens to condense the light reflected from the third mirror to be incident on the imaging body. The condensing lens may be fixed to the main body. A total distance traveled by the light reflected from the document-to-be-scanned to the imaging body may be constant. The plurality of first pulleys may be fixed to the main body. First and second ends of the open wire may be fixed to first and second portions of the main body, respectively. The imaging body may be an image sensor to convert the light received from the third mirror into electric signals. The imaging body may be a photoconductive member, and the light received from the third mirror forms a latent image on the photoconductive member.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a conventional scanning unit;

FIG. 2 is a view illustrating a conventional structure for moving two carriages of the conventional scanning unit of FIG. 1;

FIG. 3 is a schematic view illustrating a scanning unit according to an embodiment of the present general inventive concept;

FIG. 4 is a perspective view illustrating the scanning unit of FIG. 3;

FIGS. 5 and 6 are views illustrating a moving process of first and second carriages of the scanning unit of FIG. 3 according to an embodiment of the present general inventive concept;

FIG. 7 is a perspective view illustrating a synchro-mesh wire used in the scanning unit of FIG. 4 according to an embodiment of the present general inventive concept; and

FIG. 8 is a perspective view illustrating a timing belt used in the scanning unit of FIG. 4 according to an embodiment of the present general inventive concept.

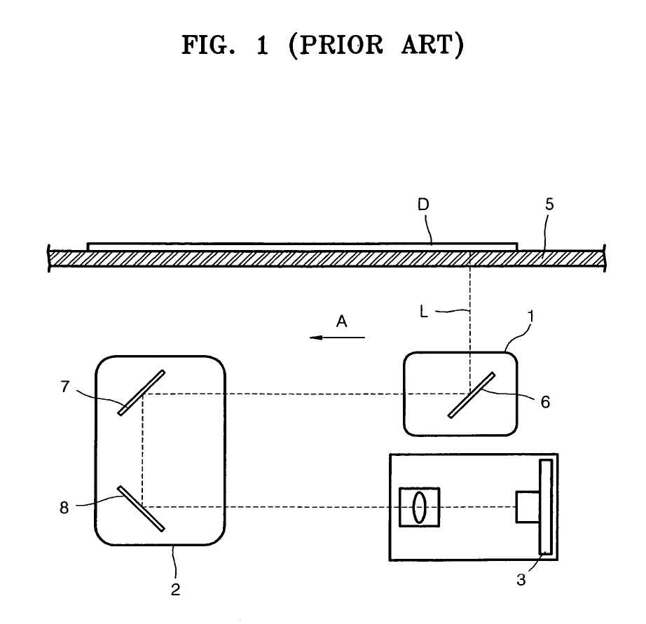

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

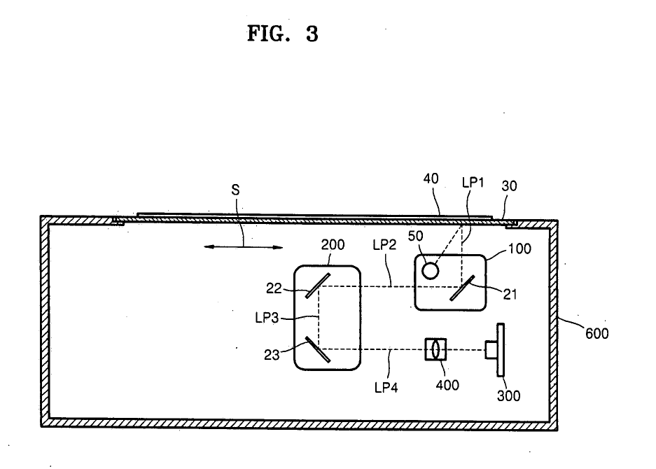

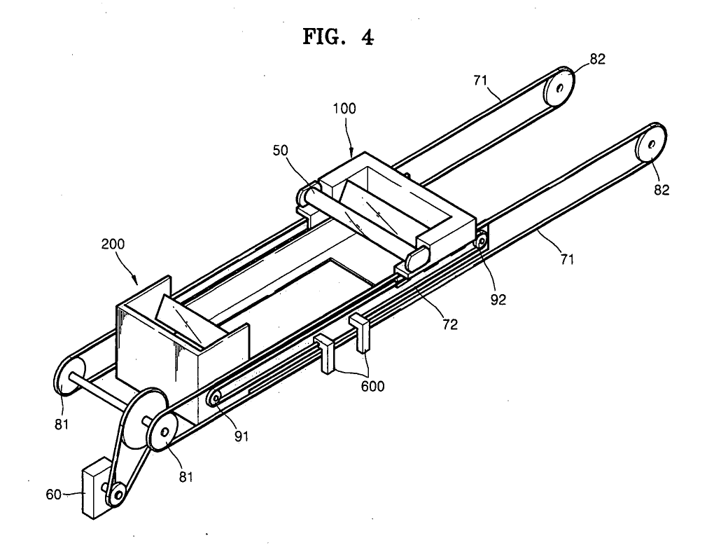

FIGS. 3 and 4 are schematic and perspective views illustrating a scanning unit according to an embodiment of the present general inventive concept. Referring to FIGS. 3 and 4, a document 40 to be scanned is placed on a plate 30. The document 40 may be, for example, a piece of paper or a book. The plate 30 may be, for example, a transparent plate. First and second carriages 100 and 200 and an imaging body 300 are installed below the plate 30. The imaging body 300 may be, for example, an image sensor to detect light reflected from the document 40 and to convert the light into an electric signal to read information from the document 40. The image sensor may be, for example, a charge coupled device (CCD). In an electrophotographic copier, the imaging body 300 is a photoconductor. The photoconductor may be, for example, a photoconductive drum or a photoconductive belt having a photoconductive film on a surface thereof. A structure of the electrophotographic copier is well known to those of ordinary skill in the art and will not be described here.

A light source 50 to radiate light to the document 40 is mounted in the first carriage 100. To guide the light reflected from the document 40 to the imaging body 300, a first reflection mirror 21 is mounted in the first carriage 100 and second and third reflection mirrors 22 and 23 are mounted in the second carriage 200. However, more than three reflection mirrors may be used.

A condensing lens 400 may be placed in front of the imaging body 300 to condense the light reflected from the document 10 onto the imaging body 300. The document 40, the condensing lens 400, and the imaging body 300 are all fixed. To scan an entire surface of the document 40, the first and second carriages 100 and 200 are moveable in a sub-scanning direction S. A guide rail (not illustrated) to guide the first and second carriages 100 and 200 moving in the sub-scanning direction S may be further provided in the scanning unit of FIG. 3. To accurately focus the light reflected from the document 40 onto the imaging body 300, a total length of light paths LP1, LP2, LP3, and LP4 from the document 40 to the condensing lens 400 should be maintained to be constant while the first and second carriages 100 and 200 are moving. To this end, in the present embodiment, a moving speed of the second carriage 200 is half of a moving speed of the first carriage 100.

Referring to FIG. 4, a first wire 71 that makes a closed loop is supported by first pulleys 81 and 82. The first pulleys 81 and 82 are fixed and the first carriage 100 is connected to the first wire 71. Second pulleys 91 and 92 are installed on (connected to) the second carriage 200. A second wire 72 that makes an open loop is supported by the second pulleys 91 and 92. Both ends of the second wire 72 are fixed to a main body 600 of the scanning unit. The second wire 72 is connected to the first carriage 100 between the second pulleys 91 and 92. A motor 60 is provided to rotate the first pulley 81, and as the motor rotates clockwise or counter-clockwise, the first wire 71 circulates in the sub-scanning direction S.

The first pulley 81 is a driving pulley. The more the first wire 71 is wound around the first pulley 81, the more a slip between the first pulley 81 and the first wire 71 is reduced, and thus the first and second carriages 100 and 200 can move precisely. The first wire 71 may be wound around the first pulley 81 a plurality of times.

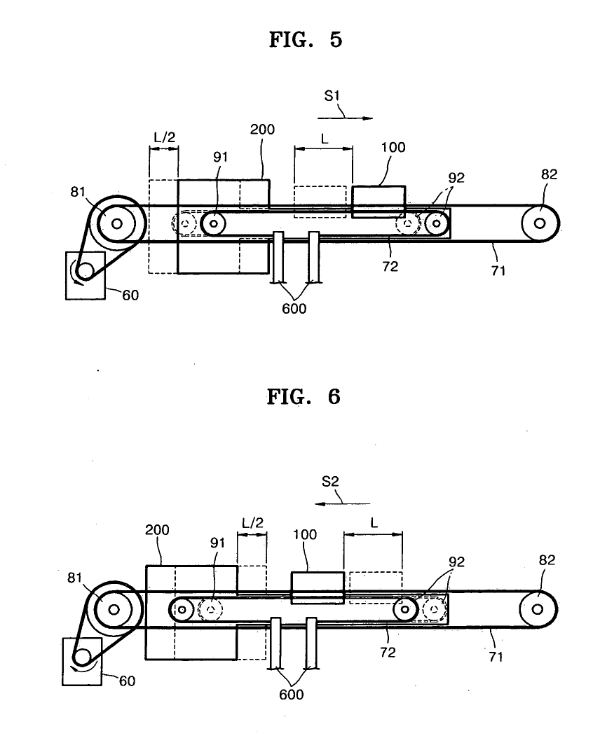

Referring to FIG. 5, the first wire 71 draws the first carriage 100 in a direction S1 when the motor 60 rotates in a clockwise direction, and the second wire 72 is also drawn in the same direction (i.e., in the direction S1) due to the connection of the second wire 72 to the first carriage 100. If the first carriage 100 is moved by a distance L in the direction S1, the second wire 72, which is connected to the first carriage 100, is also drawn by the first carriage 100 by the distance L. At this point, the second pulley 92 is drawn by the second wire 72 in the direction S1 since the second pulley 92 is connected to the second carriage 200. Since the second pulley 92 is installed in the second carriage 200, the second pulley 92 moves with the second carriage 200 half the distance L (i.e., L/2) in the direction S1. Referring to FIG. 6, if the motor 60 rotates in a counter-clockwise direction, the first carriage 100 is drawn by the first wire 71 in the direction S2 and the second wire 72 is drawn by the first carriage 100 by the distance L also in the direction S2. If the first carriage 100 is moved by a distance L in the direction S2, the second wire 72, which is connected to the first carriage 100, is also drawn by the first carriage 100 by the distance L. At this point, the second pulley 91 is drawn by the second wire 72 in the direction S2. Because the second pulley 91 is installed in the second carriage 200, the second pulley 91 moves with the second carriage 200 half the distance L (i.e., L/2) in the direction S2.

In such a configuration, the total length of the light paths LP1, LP2, LP3, and LP4 is maintained constant while the first and second carriages 100 and 200 move in the sub-scanning direction S, and the reflected light from the document 40 is focused on the imaging body 300 accurately. When the imaging body 300 is the image sensor, the light reflected from the document 40 is detected and converted into a signal to read the information of the document 40. When the imaging body 300 is the photoconductor, an electrostatic latent image corresponding to an image of the document 40 is formed on the photoconductor. Then, the electrostatic latent image is developed with a developer, for example, a toner, to duplicate the information from the document 40.

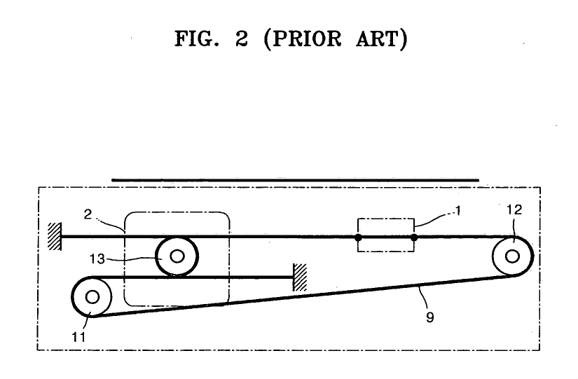

The conventional scanning unit of FIG. 2 has a complicated belt path of the belt 9 that is difficult to assemble. However, according to the scanning unit of the present embodiment, the two wires 71 and 72 are employed, which respectively form closed and open loops, and the wire route thereof is easy to assemble.

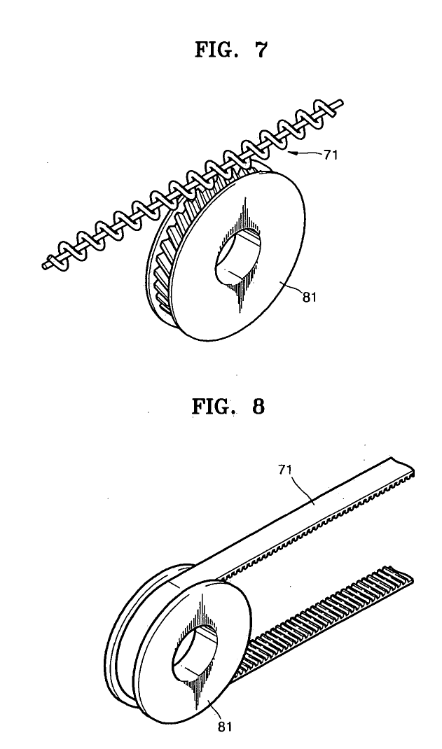

As illustrated in FIG. 7, according to an embodiment of the present general inventive concept, a synchro-mesh wire can be employed as the first wire 71 of the scanning unit of FIG. 4. The synchro-mesh wire includes a straight wire and a linear wire spirally wound around the straight wire. In this embodiment, at least a toothed pulley communicating with the spiral linear wire should be employed as the first pulley 81 rotated by the motor 60. The first pulley 82 is the same as the first pulley 81. According to another embodiment of the present general inventive concept, a toothed timing belt as illustrated in FIG. 8 can be also employed as the first wire 71 in the scanning unit of FIG. 4. In this case, a toothed timing pulley, which communicates with the toothed form of the timing belt, is employed as the first pulley 81 or 82. When the synchro-mesh wire or the timing belt are employed as the first wire 71, a slip rarely occurs, and thus the motor 60 matches precisely the movements of the carriages 100 and 200. Also, when the synchro-mesh wire or the timing wire is used, it is not necessary to wind the synchro-mesh wire or the timing wire around the first pulley 81 a plurality of times, thus simplifying the wire assembly. The second wire 72 may also be a synchro-mesh wire or a timing belt.

As described above, according to embodiments of the scanning unit of the present general inventive concept, two wires that form respectively closed and open loops are employed to move two carriages, thereby simplifying a wire path and making a wire assembly easy. Moreover, a synchro-mesh wire or a timing belt can be employed as a wire that does not need to be wound around a pulley a plurality of times, thereby improving an assembling process of the wire.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A scanning unit, comprising:
a fixed imaging body;
a first carriage including a light source to radiate light onto a document to be scanned;
a second carriage moveable with the first carriage to guide the light reflected from the document onto the imaging body;
a first wire to make a closed loop supported by a plurality of first pulleys and connected to the first carriage to move the first carriage;
a second wire to make an open loop supported by a plurality of second pulleys installed in the second carriage and connected to the first carriage; and
a motor to drive the first wire.

2. The scanning unit of claim 1, wherein the motor rotates one of the first pulleys.

3. The scanning unit of claim 1, wherein at least one of the first and second wires is a synchro-mesh wire.

4. The scanning unit of claim 1, wherein at least one of the first and second wires is a timing belt.

5. A scanning unit, comprising:
first and second carriages having one or more reflection mirrors to move in a sub-scanning direction and to guide light reflected from a document onto an imaging body;
a first wire to circulate in the sub-scanning direction and connected to the first carriage;
a second wire to form an open loop in the sub-scanning direction, supported by two pulleys in the second carriage, and connected to the first carriage between the two pulleys; and
a motor to drive the first wire.

6. The scanning unit of claim 5, wherein the first wire is one of a synchro-mesh wire and a timing belt.

7. The scanning unit of claim 1, wherein:
the first carriage includes a first mirror to receive reflected light and to further reflect the light; and
the second carriage includes second and third mirrors to receive the light reflected from the first mirror and to further reflect the light towards an imaging body.

8. An image scanning apparatus, comprising:
a main body;
imaging body; and
a scanning unit, the scanning unit comprising:
a first carriage including a first mirror to receive light reflected from a document-to-be-scanned and to further reflect the light,
a first moving unit connected to the first carriage to move the first carriage at a first speed, the first moving unit including a closed loop wire and a plurality of first pulleys to rotate the closed loop wire,
a second carriage including a plurality of second pulleys fixed thereto, and second and third mirrors to receive the light reflected from the first mirror and to further reflect the light towards the imaging body, and
a second moving unit connected to the second carriage to move the second carriage at a second speed different from the first speed, the second moving unit including an open wire connected to the first carriage to move around the plurality of second pulleys due to a movement of the first carriage.

9. The apparatus of claim 8, wherein the imaging body is fixed to the main body.

10. The apparatus of claim 8, further comprising:
a condensing lens to condense the light reflected from the third mirror to be incident on the imaging body.

11. The apparatus of claim 10, wherein the condensing lens is fixed to the main body.

12. The apparatus of claim 8, wherein a total distance traveled by the light reflected from the document-to-be-scanned to the imaging body is constant.

13. The apparatus of claim 8, wherein the plurality of first pulleys are fixed to the main body.

14. The apparatus of claim 8, wherein first and second ends of the open wire are fixed to first and second portions of the main body, respectively.

15. The apparatus of claim 8, wherein the imaging body is an image sensor to convert the light received from the third mirror into electric signals.

16. The apparatus of claim 8, wherein the imaging body is a photoconductive member, and the light received from the third mirror forms a latent image on the photoconductive member.
